(19) United States
(12) Patent Application Publication
(10) Pub. No.: US 2014/0319108 A1
(43) Pub. Date: Oct. 30, 2014

(54) CUTTING EQUIPMENT

(71) Applicant: HON HAI PRECISION INDUSTRY CO., LTD., New Taipei (TW)

(72) Inventor: YUNG-CHANG TSENG, New Taipei (TW)

(73) Assignee: HON HAI PRECISION INDUSTRY CO., LTD., New Taipei (TW)

(21) Appl. No.: 14/256,105

(22) Filed: Apr. 18, 2014

(30) Foreign Application Priority Data
Apr. 25, 2013 (TW) 102114767

(51) Int. Cl. B23K 26/067; B23K 26/08; B23K 26/38

(52) U.S. Cl. CPC B23K 26/067; B23K 26/38; B23K 26/083
USPC 219/121.67

(57) ABSTRACT

Cutting equipment is used to cut an object. The object includes at least two preformed products. The cutting equipment includes a support device and a cutting device. The support device supports the object. The cutting device includes a laser emitter configured for emitting a first laser beam, and an optical splitter configured for splitting the first laser beam into at least two second laser beams. Each second laser beam is configured for cutting the object to separate one of the at least two preformed products from the object.

### FIELD

The present disclosure relates to a cutting equipment.

### BACKGROUND

Molded product usually includes a preformed core and a connecting runner. A knife is usually used to separate the preformed core from the runner. If the knife is dull the preformed element may not be cut efficiently.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a diagrammatic view of a cutting equipment according to an exemplary embodiment of the present disclosure.

FIG. 2 is a diagrammatic, isometric view of an object to be cut.

FIG. 3 illustrates using the cutting equipment of FIG. 1 to cut the object of FIG. 2.

### DETAILED DESCRIPTION

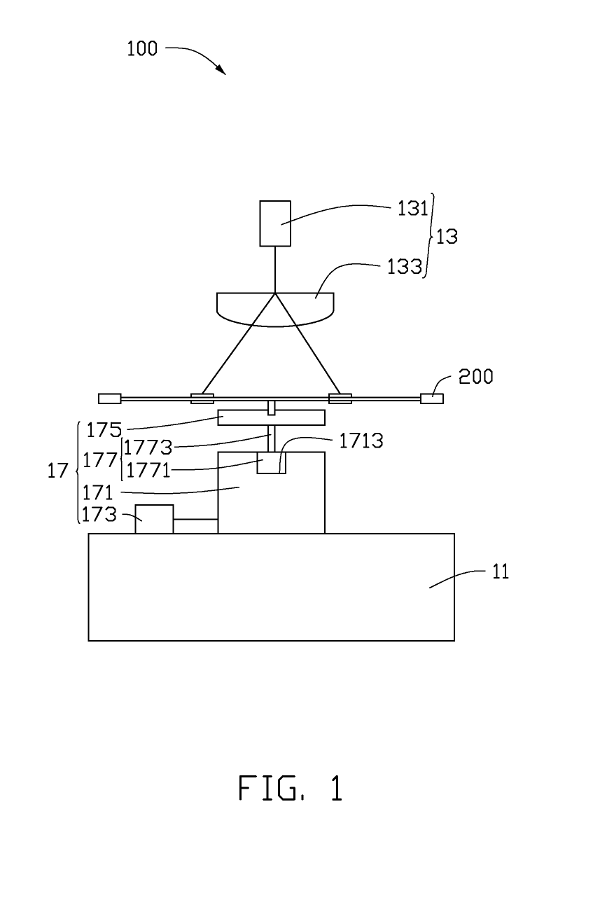

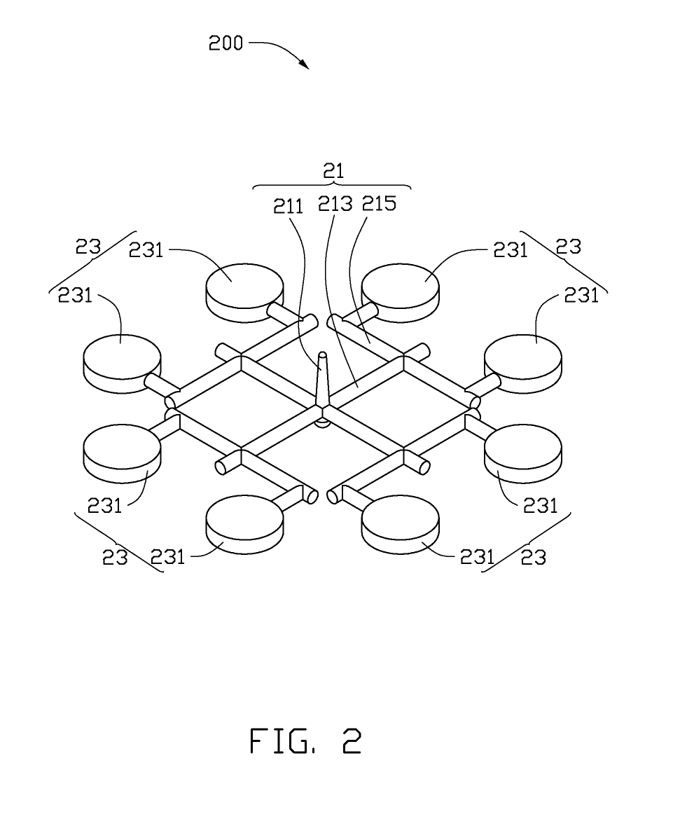

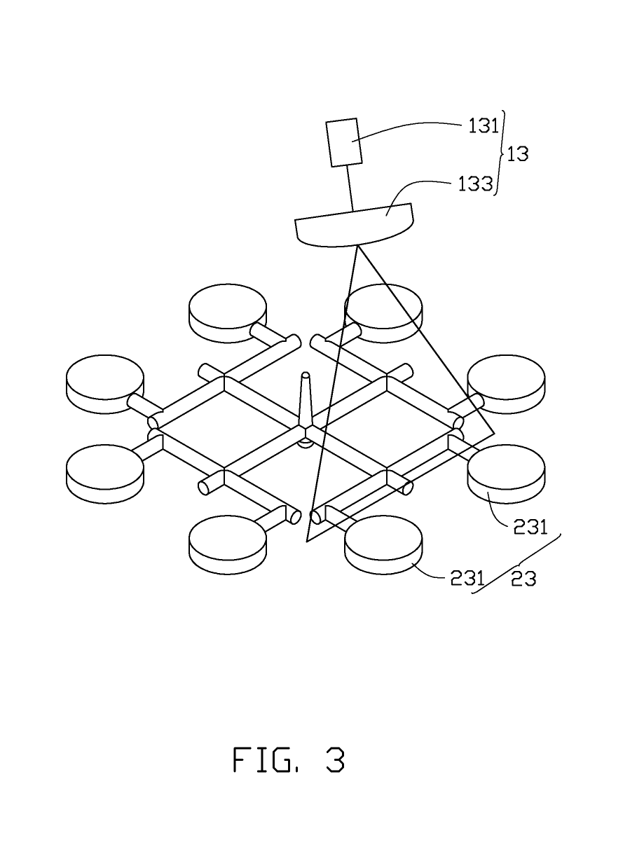

FIGS. 1 through 3 illustrate cutting equipment 100, for cutting an object 200. The object 200 (as shown in FIG. 2) includes a runner 21 and four preformed product groups 23. Each performed product group 23 includes two preformed products 231 aligned along a straight line. The runner 21 includes a main trunk 211, four primary branches 213 and eight secondary branches 215. The four primary branches 213 extend radially from the main trunk 211 and are located on a same plane. Each primary branch 213 corresponds to a preformed product group 23 and is connected to two secondary branches 215. The two secondary branches 215 are symmetrical about the primary branch 215. Each secondary branch 215 is connected to one of the preformed product 231.

The cutting equipment 100 (as shown in FIG. 1) includes a support device 11, a cutting device 13 and a transport device 17.

The support device 11 movably supports the transport device 17.

The cutting device 13 includes a laser emitter 131 and an optical splitter 133. The laser emitter 131 emits a laser beam, the optical splitter 133 splits the laser beam into at least two laser beams. The at least two laser beams are located on the same plane. In this embodiment, the at least two laser beams includes two laser beams, one for cutting one preformed product 231 of one preformed product group 23, the other for cutting the other preformed product 231 of the preformed product group 23. The optical splitter 133 can be a cylindrical lens, a spectroscopic grating, a prism, or a polygon mirror.

The transport device 17 supports the object 200 and drives the object 200 to move relative to the support device 11. The transport device 17 includes a movable stage 171, a first drive unit 173, a rotatable stage 175 and a second drive unit 177.

The movable stage 171 is movably supported by the support device 11, and supports the rotatable stage 175. In this embodiment, the movable stage 171 defines a receiving groove 1713 in a surface away from the support device 11. The second drive unit 177 is received in the receiving groove 1713.

The first drive unit 173 is mounted on the support device 11 and is connected to the movable stage 171. The first drive unit 173 drives the movable stage 171 to move relative to the support device 11.

The rotatable stage 175 is rotatably mounted on the movable stage 171 via the second drive unit 177. The rotatable stage 177 supports the object 200.

The second drive unit 177 includes a stator 1771 and a rotor 1773 connected to the stator 1771. The stator 1771 is received in the receiving groove 1713. The rotatable stage 175 is connected to the rotor 1773. When the rotor 1773 rotates, the rotatable stage 175 rotates too. When one preformed product group 23 is separated from the object 200 by the cutting device 13, the rotatable stage 175 rotates to make a next preformed product group 23 move to a cutting position, then the cutting device 13 cuts the next preformed product group 23. The above mentioned procedures are repeated until all the preformed product groups 23 are separated from the object 200.

The cutting equipment 100 uses a laser beam to cut the object 200. The laser beam will not dull and can cut the object efficiently. Furthermore, the optical splitter 133 can split one laser beam into two laser beams, which can cut two preformed products 231 simultaneously, thus, the cutting efficiency is further improved.

It will be understood that the above particular embodiments are shown and described by way of illustration only. The principles and the features of the present disclosure may be employed in various and numerous embodiments thereof without departing from the scope of the disclosure. The above-described embodiments illustrate the scope of the disclosure but do not restrict the scope of the disclosure.

What is claimed is:

1. A cutting equipment used to cut an object, the object comprising at least two preformed products, the cutting equipment comprising:
a support device configured for supporting the object; and
a cutting device comprising:
a laser emitter configured for emitting a first laser beam; and
an optical splitter configured for splitting the first laser beam into at least two second laser beams, each second laser beam configured for cutting the object to separate one of the at least two preformed product from the object.

2. The cutting equipment of claim 1, wherein the optical splitter is a cylindrical lens.

3. The cutting equipment of claim 1, wherein the optical splitter is a spectroscopic grating.

4. The cutting equipment of claim 1, wherein the optical splitter is a prism.

5. The cutting equipment of claim 1, wherein the optical splitter is a polygon mirror.

6. The cutting equipment of claim 1, further comprising a transport device supported by the support device and configured for driving the object to move relative to the support device.

7. The cutting device of claim 6, wherein the transport device comprises a movable stage and a first drive unit, the movable stage is supported by the support device, the first drive unit is mounted on the support device and is connected to the movable stage, the first drive unit drives the movable stage to move relative to the support device.

8. The cutting device of claim 7, wherein the transport device further comprises a rotatable stage and a second drive unit, the second drive unit is mounted on the movable stage, the rotatable stage is connected to the second drive unit, the second drive unit drives the rotatable stage to rotate relative to the movable stage, the rotatable stage supports the object.
